(19) United States
(12) Patent Application Publication
(10) Pub. No.: US 2023/0046615 A1
(43) Pub. Date: Feb. 16, 2023

(54) BIOMASS-BASED PESTICIDES AND METHODS OF MAKING THE SAME

(71) Applicant: Alliance for Sustainable Energy, LLC, Golden, CO (US)

(72) Inventors: Andrew Nolan WILSON, Denver, CO (US); Mark R. Nimlos, Golden, CO (US); John R. DORGAN, East Lansing, MI (US)

(21) Appl. No.: 17/783,316

(22) PCT Filed: Dec. 21, 2020
(86) PCT No.: PCT/US20/66306

§ 371 Date: Jun. 8, 2022

Related U.S. Application Data
(60) Provisional application No. 62/950,443, filed on Dec. 19, 2019.

(51) Int. Cl. A01N 31/16; A01N 31/08; A01P 7/04

(52) U.S. Cl. CPC A01N 31/16; A01N 31/08; A01P 7/04

(57) ABSTRACT

The present disclosure relates to a composition that includes a compound having the structure of a phenolic with three functional groups, R₁ R₂, and R₃, where R₁ includes at least one of a hydrogen atom, a hydroxyl group, a first alkoxy group, and/or a first hydrocarbon, R₂ includes at least one of a hydrogen atom, a hydroxyl group, a second alkoxy group, and/or a second hydrocarbon, R₃ includes at least one of a hydrogen atom, a hydroxyl group, a third alkoxy group, and/or a third hydrocarbon, and the composition has an LC₅₀ of less than about 150 mg compound per mL of the composition for an organism that includes the genus Leptinotarsa.

### CROSS-REFERENCE TO RELATED APPLICATIONS

This application claims priority from U.S. Provisional Patent Application No. 62/950,443 filed on Dec. 19, 2019, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Current biomass-based pesticidesperform poorly due to expensive production methods, and low activities. Compared to synthetic pesticides derived from fossil resources, biomass-based pesticides are inherently less toxic, tend to kill/mitigate a narrower spectrum of pests, and decompose more quickly in the environment. However, improvements to biomass-based pesticides are highly desired; such improvements include lower LC₅₀ concentrations (the concentration of an active component needed to kill at least 50% of a starting population of pests, within a defined time period), more defined active compounds, and/or synergistic mixtures of compounds with higher effectiveness. In addition to greater effectiveness, better methods for economically producing these active compounds from biomass are needed. These desired but unmet needs may be addressed through producing pyrolysis oils from biomass, such biomass-based pesticides provide better insecticidal activity at lower costs when compared against other biomass-based compounds derived using other methods.

### SUMMARY

An aspect of the present disclosure is a composition that includes a compound having the structure

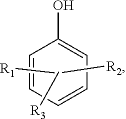

where R₁ includes at least one of a hydrogen atom, a hydroxyl group, a first alkoxy group, and/or a first hydrocarbon, R₂ includes at least one of a hydrogen atom, a hydroxyl group, a second alkoxy group, and/or a second hydrocarbon, R₃ includes at least one of a hydrogen atom, a hydroxyl group, a third alkoxy group, and/or a third hydrocarbon, and the composition has an LC₅₀ of less than about 150 mg of the compound per mL of the composition for an organism that includes the genus Leptinotarsa.

In some embodiments of the present disclosure, the compound may be bioderived as determined by ASTM-D6866. In some embodiments of the present disclosure, the compound may be derived from an oil formed by catalytic fast pyrolysis of biomass. In some embodiments of the present disclosure, at least one of the first hydrocarbon, the second hydrocarbon, and/or the third hydrocarbon may include between 1 and 5 carbon atoms (i.e. each individual group has between 1 and 5 carbon atoms, inclusively). In some embodiments of the present disclosure, at least one of the first alkoxy group, the second alkoxy group, and/or the third alkoxy group may include between 1 and 5 carbon atoms (i.e. each individual group has between 1 and 5 carbon atoms, inclusively).

In some embodiments of the present disclosure, the compound may include at least one of a trimethyl phenol, an ethyl-methyl phenol, a 4-carbon, a 5-carbon phenol, a dimethyl phenol, an ethyl phenol, a propyl phenol, and/or a methoxy phenol. In some embodiments of the present disclosure, the 4-carbon phenol may include 2-methyl-5-(1-methylethyl). In some embodiments of the present disclosure, the 5-carbon phenol may include 2-ethyl-5-n-propyl phenol. In some embodiments of the present disclosure, the compound may include at least one of 4-methyl-1,2-benzenediol, a creosol, 4-ethylcatechol, 2,6-dimethyl-1,4-benzenediol, 2-methoxy-phenol, 4-hydroxy-3-methoxy-benzoic acid, 3-methyl-1,2-benzenediol, 4-ethyl-2-methoxy-phenol, 3,6-dimethyl-benzo[B]thiophene, 3,4-dimethoxy-phenol, p-cresol, 2,4-dimethyl-phenol, 2-methyl-phenol, hydroquinone, 4,5-dimethyl-1,3-benzenediol, 2-methoxy-4-propyl-phenol, and/or phenol.

In some embodiments of the present disclosure, the compound may include at least one of 2-ethyl-5-n-propylphenol, 2-methyl-6-propylphenol, 2,5-diethylphenol, phenol, 2-(1-methylethyl)-phenol, 2-ethyl-phenol, 2-ethyl-4-methyl-phenol, 2-ethyl-4,5-dimethyl-phenol, 2-ethyl-5-methyl-phenol, 2-ethyl-6-methyl-phenol, 2-methoxy-phenol, 2-methoxy-3-(2-propenyl)-phenol, 2-methoxy-4-(1-propenyl)-phenol, (Z)-phenol, 2-methoxy-4-propyl-phenol, 2-methyl-phenol, 2-methyl-5-(1-methylethyl)-phenol, 2-propyl-phenol, 2,3-dimethyl-phenol, 2,3,6-trimethyl-phenol, 2,4,6-trimethyl-phenol, 2,6-dimethyl-phenol, 3-(1-methylethyl)-phenol, 3-ethyl-phenol, 3-methyl-phenol, 3-propyl-phenol, 3,4-dimethyl-phenol, 3,4,5-trimethyl-phenol, 4-(2-propenyl)-phenol, 4-ethyl-phenol, 4-methyl-benzenediol, and/or any other alkyl-benzenediol.

In some embodiments of the present disclosure, the LC₅₀ may be effective for the organism further including at least one organism from the genus Trichoplusia, the genus Spodoptera, and/or the genus Drosophila. In some embodiments of the present disclosure, the organism may be in a stage of growth that includes at least one of a larval stage, a pupal stage, and/or an adult stage.

An aspect of the present disclosure is a method that includes a second separating of a compound that includes the structure

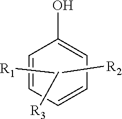

from an oil stream, where R₁ includes at least one of a hydrogen atom, a hydroxyl group, a first alkoxy group, and/or a first hydrocarbon, R₂ includes at least one of a hydrogen atom, a hydroxyl group, a second alkoxy group, and/or a second hydrocarbon, R₃ includes at least one of a hydrogen atom, a hydroxyl group, a third alkoxy group, and/or a third hydrocarbon, and the composition has an LC₅₀ of less than about 150 ml compound/kg composition for an organism comprising the genus Leptinotarsa.

In some embodiments of the present disclosure, the method may further include, prior to the second separating, an initial separating of the oil stream and a secondary stream from a crude oil stream, where the crude oil stream includes the compound derived from pyrolysis of a biomass stream. In some embodiments of the present disclosure, the method may further include, prior to the initial separating, producing the crude oil stream by pyrolyzing the biomass in at least one of a fast pyrolysis process and/or a catalytic fast pyrolysis process.

An aspect of the present disclosure is a method that includes applying the composition to an organism, where the applying results in the organism's metabolism being affected such that the organism is unable to function normally, and the composition includes a compound having the structure

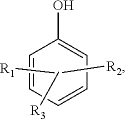

where R₁ includes at least one of a hydrogen atom, a hydroxyl group, a first alkoxy group, and/or a first hydrocarbon, R₂ includes at least one of a hydrogen atom, a hydroxyl group, a second alkoxy group, and/or a second hydrocarbon, R₃ includes at least one of a hydrogen atom, a hydroxyl group, a third alkoxy group, and/or a third hydrocarbon, and the composition has an LC₅₀ of less than about 150 mg of the compound per mL of the composition for an organism that includes the genus Leptinotarsa.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 illustrates a method for producing compounds having pesticidal activity, according to some embodiments of the present disclosure.

FIG. 2 illustrates weight percentages for compounds and groups of compounds having pesticidal activity resulting from the fractionation of catalytic fast pyrolysis (CFP) oil using vacuum distillation, according to some embodiments of the present disclosure.

FIG. 3 illustrates (A) a scheme for producing bioderived pesticides, according to some embodiments of the present disclosure. CFP oil was treated via batch, vacuum distillation and separated into several fractions, including an oil stream that included a variety of compounds having pesticidal activity and (B) compositional analysis of each fraction by GC-MS/FID, according to some embodiments of the present disclosure.

FIG. 4 illustrates dose response curves showing the activity of CFP fractions vary based on which fractions are used as the active compound, according to some embodiments of the present disclosure.

FIG. 5 illustrates A) a compositional analysis of CFP fractions with chemical groupings, B) linear correlation coefficients as a function of chemical sub-group, and C) a general structure-function relationship for increased mortality, according to some embodiments of the present disclosure.

FIG. 6 illustrates LC₅₀ values for three different organisms from compounds separated at different temperatures for the second separating step described herein, using distillation, from two different oils made by different pyrolysis methods, according to some embodiments of the present disclosure.

### REFERENCE NUMERALS

105 biomass stream
110 pyrolyzing
115 crude oil stream
120 initial separating
130 extracting
135 purified oil stream
140 second separating
145 product stream
150 crystallizing
155 purified product stream
system
210 pyrolysis process
220 first separation process
230 extraction unit
240 second separation process
250 crystallization unit

### DETAILED DESCRIPTION

The present disclosure may address one or more of the problems and deficiencies of the prior art discussed above. However, it is contemplated that some embodiments as disclosed herein may prove useful in addressing other problems and deficiencies in a number of technical areas. Therefore, the embodiments described herein should not necessarily be construed as limited to addressing any of the particular problems or deficiencies discussed herein.

References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The present disclosure relates to biomass-derived pesticides and methods of making biomass-derived pesticides. In some embodiments of the present disclosure, a biomass-derived pesticide may be obtained from mixtures of compounds produced by pyrolysis, for example, catalytic fast pyrolysis (CFP). In general, CFP is a process where carbonaceous material (e.g. biomass, fossil fuels, and/or waste plastic) is chemically reformed via heat in the absence of oxygen and in the presence of a catalyst. In some embodiments of the present disclosure, CFP may be performed by heating a carbonaceous material(s) to a temperature range between about 350° C. and about 800° C. CFP may be preferable over uncatalyzed fast pyrolysis, as CFP may produce a higher yield of phenolics. Phenolics may be preferable, as they are relatively easy to separate from pyrolysis oil (e.g. by distillation) compared to non-phenolic compounds. In some embodiments of the present disclosure, the active compounds of a biomass-derived pesticide may be produced by CFP, where the CFP produces a mixture of various compounds in a liquid phase. A liquid mixture resulting from CFP and/or fast pyrolysis (FP) may include a first liquid phase of primarily non-water-soluble organic compounds (e.g. an oil phase) and/or a second liquid phase of primarily water-soluble organic compounds (e.g. an aqueous phase). In some embodiments of the present disclosure, as shown herein, a first oil phase and/or a second aqueous phase resulting from pyrolysis, may be subsequently treated to separate the active compounds (e.g. having pesticidal activity) from the less-active and/or non-active compounds. In some embodiments of the present disclosure, a CFP product may be separated into its constituent components, including the active compound and/or compounds used in a biomass-derived pesticide, by any suitable separation operation. Examples of separation operations that may be used to isolate at least one active compound to be utilized as a pesticide includes at least one of liquid-liquid extraction, distillation, crystallization, chromatography, adsorption, membrane separations, and/or absorption. In some embodiments of the present disclosure, the mixtures resulting from CFP may be separated into streams of varying compositions and recombined in varying proportions to make new mixtures having improved physical properties (desirable viscosity, low freezing temperatures, lower or higher volatility) and/or improved pesticidal activity (greater or lesser lethality, narrower or broader spectrum of activity, etc.).

In some embodiments of the present disclosure, a pesticide active compound may be a ketone and/or phenolic and/or some other pyrolysis product. In some embodiments of the present disclosure, a pesticide active compound may include a cycloketone (e.g. cyclopentenone) and/or a methoxyphenol compound. A biomass-derived pesticide may be a single active compound and/or a mixture of two or more active compounds. These compounds can be derived using a number of biomass conversion processes including fast pyrolysis, catalytic fast pyrolysis, biocatalytic processes, catalytic processes, hydrothermal liquefaction processes, various fractionation and pretreatment processes, and from pulping and/or digestion processes. In some embodiments of the present disclosure, the active compound in a biomass-derived pesticide may be a chemical compound that includes at least one of a phenol group and/or a ketone group.

In some embodiments of the present disclosure, a pyrolysis-derived compound having pesticidal activity may have a structure as shown below,

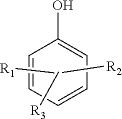

general compound

where R₁ may include at least one of a hydrogen atom, a hydroxyl group, a first alkoxy group, and/or a first hydrocarbon. In some embodiments of the present disclosure, a first hydrocarbon may include between 1 and 10 carbon atoms, or between 1 and 5 carbons. For example, a first hydrocarbon may include an alkyl group such as a methyl group, an ethyl group, a propyl group, a butyl group, and/or a pentyl group. A first hydrocarbon may be a straight-chained alkyl group and/or a branched alkyl group. In some embodiments of the present disclosure, a first hydrocarbon may be a saturated hydrocarbon or an unsaturated hydrocarbon. An unsaturated first hydrocarbon may be mono-unsaturated or poly-unsaturated. In some embodiments of the present disclosure, a first hydrocarbon may include at least one additional element in addition to hydrogen and carbon; e.g. oxygen, sulfur, nitrogen, phosphorus, and/or a halogen.

In some embodiments of the present disclosure, a first alkoxy group may include between 1 and 10 carbon atoms, or between 1 and 5 carbon atoms. For example, a first alkoxy group may include a methoxy group, an ethoxy group, a propoxy group, a butoxy group, and/or a pentoxy group. A first alkoxy group may be a straight-chained alkoxy group and/or a branched alkoxy group. In some embodiments of the present disclosure, a first alkoxy may include at least one of a carbon-carbon double bond and/or a carbon-carbon triple bond. In some embodiments of the present disclosure, a first alkoxy group may include at least one additional element in addition to hydrogen and carbon; e.g. oxygen, sulfur, nitrogen, phosphorus, and/or a halogen. In some embodiments of the present disclosure, R₁ may include an aryloxy group.

R₂ may include at least one of a hydrogen atom, a hydroxyl group, a second alkoxy group, and/or a second hydrocarbon. In some embodiments of the present disclosure, a second hydrocarbon may include between 1 and 10 carbon atoms, or between 1 and 5 carbons. For example, a second hydrocarbon may include an alkyl group such as a methyl group, an ethyl group, a propyl group, a butyl group, and/or a pentyl group. A second hydrocarbon may be a straight-chained alkyl group and/or a branched alkyl group. In some embodiments of the present disclosure, a second hydrocarbon may be a saturated hydrocarbon or an unsaturated hydrocarbon. An unsaturated second hydrocarbon may be mono-unsaturated or poly-unsaturated. In some embodiments of the present disclosure, a second hydrocarbon may include at least one additional element in addition to hydrogen and carbon; e.g. oxygen, sulfur, nitrogen, phosphorus, and/or a halogen.

In some embodiments of the present disclosure, a second alkoxy group may include between 1 and 10 carbon atoms, or between 1 and 5 carbon atoms. For example, a second alkoxy group may include a methoxy group, an ethoxy group, a propoxy group, a butoxy group, and/or a pentoxy group. A second alkoxy group may be a straight-chained alkoxy group and/or a branched alkoxy group. In some embodiments of the present disclosure, a second alkoxy may include at least one of a carbon-carbon double bond and/or a carbon-carbon triple bond. In some embodiments of the present disclosure, a second alkoxy group may include at least one additional element in addition to hydrogen and carbon; e.g. oxygen, sulfur, nitrogen, phosphorus, and/or a halogen. In some embodiments of the present disclosure, R₂ may include an aryloxy group.

R₃ may include at least one of a hydrogen atom, a hydroxyl group, a third alkoxy group, and/or a third hydrocarbon. In some embodiments of the present disclosure, a third hydrocarbon may include between 1 and 10 carbon atoms, or between 1 and 5 carbons. For example, a third hydrocarbon may include an alkyl group such as a methyl group, an ethyl group, a propyl group, a butyl group, and/or a pentyl group. A third hydrocarbon may be a straight-chained alkyl group and/or a branched alkyl group. In some embodiments of the present disclosure, a third hydrocarbon may be a saturated hydrocarbon or an unsaturated hydrocarbon. An unsaturated third hydrocarbon may be mono-unsaturated or poly-unsaturated. In some embodiments of the present disclosure, a third hydrocarbon may include at least one additional element in addition to hydrogen and carbon; e.g. oxygen, sulfur, nitrogen, phosphorus, and/or a halogen.

In some embodiments of the present disclosure, a third alkoxy group may include between 1 and 10 carbon atoms, or between 1 and 5 carbon atoms. For example, a third alkoxy group may include a methoxy group, an ethoxy group, a propoxy group, a butoxy group, and/or a pentoxy group. A third alkoxy group may be a straight-chained alkoxy group and/or a branched alkoxy group. In some embodiments of the present disclosure, a third alkoxy may include at least one of a carbon-carbon double bond and/or a carbon-carbon triple bond. In some embodiments of the present disclosure, a third alkoxy group may include at least one additional element in addition to hydrogen and carbon; e.g. sulfur, nitrogen, phosphorus, and/or a halogen. In some embodiments of the present disclosure, R₃ may include an aryloxy group. In some embodiments of the present disclosure a compound having pesticidal activity may include at least on of a benzenediol, an alkylated benzenediol, an alkylated phenol, and/or an alkoxy phenol.

In some embodiments of the present disclosure, a compound having pesticidal activity may include at least one of a trimethyl phenol, an ethyl-methyl phenol, a 4-carbon phenol (where “4-carbon” refers to a functional group having 4 carbon atoms attached to phenol), a 5-carbon phenol, a dimethyl phenol, an ethyl phenol, a propyl phenol, and/or a methoxy phenol. For example, a 4-carbon phenol may include 2-methyl-5-(1-methylethyl) phenol, or 2-(1-methylpropyl) phenol. Examples of a 5-carbon phenol includes at least one of 2-ethyl-5-n-propyl phenol or 2-(1,1-dimethylethyl)-4-methyl phenol. In some embodiments of the present disclosure, a compound having pesticidal activity may include at least one of 4-methyl-1,2-benzenediol, creosol (i.e. 2-methoxy-4-methylphenol and/or its isomers), 4-ethylcatechol, and/or 2,6-dimethyl-1,4-benzenediol.

In some embodiments of the present disclosure, a compound having pesticidal activity may include at least one of 4-methyl-1,2-benzenediol, a creosol, 4-ethylcatechol, 2,6-dimethyl-1,4-benzenediol, 2-methoxy-phenol, 3-methoxy-phenol, 4-methoxy-phenol, 4-hydroxy-3-methoxy-benzoic acid, 3-methyl-1,2-benzenediol, 4-ethyl-2-methoxy-phenol, 3,6-dimethyl-benzo[B]thiophene, 3,4-dimethoxy-phenol, p-cresol, o-cresol, m-cresol, 2,4-dimethyl-phenol, 2-methyl-phenol, hydroquinone, 4,5-dimethyl-1,3-benzenediol, 2-methoxy-4-propyl-phenol, and/or phenol.

In some embodiments of the present disclosure, a compound having pesticidal activity may include at least one of 2-ethyl-5-n-propylphenol, 2-methyl-6-propylphenol, 2,5-diethylphenol, phenol, 2-(1-methylethyl)-phenol, 2-ethyl-phenol, 2-ethyl-4-methyl-phenol, 2-ethyl-4,5-dimethyl-phenol, 2-ethyl-5-methyl-phenol, 2-ethyl-6-methyl-phenol, 2-methoxy-phenol, 2-methoxy-3-(2-propenyl)-phenol, 2-methoxy-4-(1-propenyl)-phenol, (Z)-phenol, 2-methoxy-4-propyl-phenol, 2-methyl-phenol, 2-methyl-5-(1-methylethyl)-phenol, 2-propyl-phenol, 2,3-dimethyl-phenol, 2,3,6-trimethyl-phenol, 2,4,6-trimethyl-phenol, 2,6-dimethyl-phenol, 3-(1-methylethyl)-phenol, 3-ethyl-phenol, 3-methyl-phenol, 3-propyl-phenol, 3,4-dimethyl-phenol, 3,4,5-trimethyl-phenol, 4-(2-propenyl)-phenol, 4-ethyl-phenol, 4-methyl-benzenediol, and/or any other alkyl-benzenediol.

Without being bound by theory, in some embodiments of the present disclosure, one or more compounds having pesticial activity may provide this activity by blocking a receptor binding site such as the octopamine receptor binding site of the targeted organism, disrupting the GABA receptors of the targeted organism, and/or any other molecular pathway in the targeted organisim's metabolism that leads to the death of the organism.

As shown herein, in some embodiments of the present disclosure, a compound (see the general compound shown above) may be characterized by a minimum LC₅₀ of less than a certain amount and/or concentration (LC₅₀ refers to the statistically derived concentration at which 50% of the population will be expected to die). For example, in some embodiments of the present disclosure, a compound having pesticidal activity may be characterized by an LC₅₀ of about 150 mg of at least one active compound per mL of a total mixture or less for an organism that includes the Colorado Potato Beatle (Leptinotarsa decemlineata). In some embodiments of the present disclosure, a suitable LC₅₀ may be between about 0.1 mg/mL and about 150 mg/mL, or between about 0.1 mg/mL and about 10 mg/mL. In some embodiments of the present disclosure, a compound having pesticidal activity may be characterized by an LC₅₀ of about 150 mg compound/mL or less for an organism that includes the Cabbage Looper (Trichoplusia ni). In some embodiments of the present disclosure, a compound having pesticidal activity may be characterized by an LC₅₀ of about 150 mg compound/mL or less for an organism including an organism from at least one of the genus Letinotarsa, the genus Trichoplusia, the genus Spodoptera, and/or the genus Drosophila. In some embodiments of the present disclosure, a compound having pesticidal activity may be characterized by an LC₅₀ of about 150 mg compound/mL or less for an organism including at least one of the Beet Armyworm (Spodoptera exigua) the Spotted Wing Drosophila (Drosophila suzukii), the Colorado Potato Beatle (Leptinotarsa decemlineata), the Cabbage Looper (Trichoplusia ni), the Beet Armyworm (Spodoptera exigua), the Confused Flour Beetle, the Red Flour Beetle, and/or the Saw-toothed Grain Beetle. In some embodiments of the present disclosure, a compound as described herein may have pesticidal activity for an organism in a stage of growth that includes at least one of a larval stage, a pupal stage, and/or an adult stage.

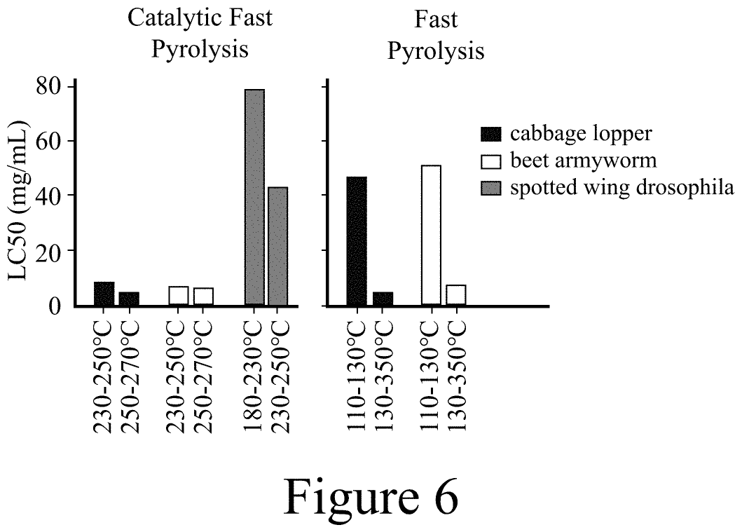

In some embodiments of the present disclosure, a compound having pesticidal activity may be included in a mixture that includes at least one other ingredient or compound, which may be obtained by tuning the operating conditions of the pyrolysis process; e.g., the biomass to catalyst ratio, the pyrolysis temperature, an upgrading temperature, and/or pyrolysis catalyst type. In some embodiments of the present disclosure, a compound having pesticidal activity may be combined with a solvent to form a mixture, where the mixture results in a concentration about equal to the LC₅₀. In some embodiments of the present disclosure, a solvent may include a polar solvent such as water. In some embodiments of the present disclosure, a single compound having pesticidal activity may be present in a pesticidal mixture including a solvent at a concentration up to about 50 wt %, or in a range between about 1 wt % and about 20 wt %. Some examples of possible concentrations for some exemplary compounds are summarized in Table 1, below. Referring to Table 1, Active Fraction A corresponds a batch distillation product collected over a temperature range of 130° C. to 350° C., at about 30 Torr of pyrolysis oil made by Fast Pyrolysis); Active Fraction B corresponds to a batch distillation produce collected over a temperature range of 230 C.° to 250° C., at about 30 Torr of pyrolysis oil made by catalytic fast pyrolysis using Pt/TiO₂ catalyst, and Active Fraction C corresponds to a batch distillation produce collected over a temperature range of 250 C.° to 270° C., at about 30 Torr of pyrolysis oil made by catalytic fast pyrolysis using Pt/TiO₂ catalyst. The method/process will be described in more detail below. FIG. 6 illustrates the LC50 values of three different organisms, cabbage lopper, beet armyworm, and the spotted wing drosophila, resulting from these various fractions of the distilled pyrolysis oils.

TABLE 1
Examples of Pesticidal Compounds and Concentrations (wt %)

| | | Active | Active | Active |
|---|---|---|---|---|
| Compound Name | cas | Fraction A | Fraction B | Fraction C |
| 1,2-Benzenediol, 4-methyl- | 000452-86-8 | 7.8% | | 1.4% |
| 1,2-Cyclopentanedione, 3-methyl- | 000765-70-8 | | | 0.3% |
| 1,3-Benzenediol, 4,5-dimethyl- | 000527-55-9 | 0.8% | | 0.2% |
| 1,3-Benzodioxole, 5-propyl- | 000094-58-6 | | 0.4% | |
| 1,3-Cyclopentadiene, 5,5-dimethyl-1,2-Dipropyl- | 1000163-88-0 | | 0.6% | |
| 1-Naphthalenol | 000090-15-3 | | | 0.2% |
| 1H-Inden-5-ol, 2,3-dihydro- | 001470-94-6 | | 2.9% | 1.6% |
| 2(5H)-Furanone | 000497-23-4 | | 0.3% | |
| 2-Cyclopenten-1-one, 2,3-dimethyl- | 001121-05-7 | 0.1% | 0.1% | |
| 2-Cyclopenten-1-one, 3-methyl- | 002758-18-1 | | 0.6% | |
| 2-Ethyl-5-n-propylphenol | 072386-20-0 | | 2.2% | |
| 2-Methoxy-4-vinylphenol | 007786-61-0 | | | 0.8% |
| 2-Methoxy-5-methylphenol | 001195-09-1 | | | 3.5% |
| 4-Hydroxy-3-methylacetophenone | 000876-02-8 | | 2.3% | |
| 4-Methyl-5H-furan-2-one | 006124-79-4 | | 2.5% | |
| 6-Methyl-4-indanol | 020294-32-0 | | 0.5% | |
| 9H-Fluorene, 2-methyl- | 001430-97-3 | | | 0.1% |
| Benzene, 1-ethyl-4-methoxy- | 001515-95-3 | 0.3% | 0.9% | |
| Benzene, 1-methoxy-4-(1-methylpropyl)- | 004917-90-2 | | 0.3% | |
| Benzene, hexamethyl- | 000087-85-4 | | 0.1% | 0.0% |
| Eugenol | 000097-53-0 | | 6.0% | 0.2% |
| Furan, 2-(methoxymethyl)- | 013679-46-4 | | 0.4% | |
| Heptadecane | 000629-78-7 | | 0.0% | |
| Hydroquinone | 000123-31-9 | 0.5% | | 1.7% |
| Naphthalene, 1,4,6-trimethyl- | 002131-42-2 | | 0.1% | |
| Naphthalene, 1,6,7-trimethyl- | 002245-38-7 | | 0.1% | |
| Naphthalene, 2,6-dimethyl- | 000581-42-0 | | 0.1% | |
| Phenol | 000108-95-2 | 0.4% | 0.3% | 0.2% |
| Phenol, 2,3,5-trimethyl- | 000697-82-5 | | 1.2% | |
| Phenol, 2,3-dimethyl- | 000526-75-0 | | 0.4% | |
| Phenol, 2,4,5-trimethyl- | 000496-78-6 | | 0.3% | |
| Phenol, 2,5-dimethyl- | 000095-87-4 | 0.1% | | 0.0% |
| Phenol, 2,4-dimethyl- | 000105-67-9 | | 0.5% | |
| Phenol, 2-(1,1-dimethylethyl)-4-methyl- | 002409-55-4 | | 0.1% | |
| Phenol, 2-(1-methylpropyl)- | 000089-72-5 | | 1.0% | |
| Phenol, 2-ethyl-4-methyl- | 003855-26-3 | | 0.5% | |
| Phenol, 2-methoxy- | 000090-05-1 | 2.1% | 0.7% | 1.1% |
| Phenol, 2-methoxy-4-propyl- | 002785-87-7 | 0.5% | 0.8% | 0.5% |
| Phenol, 2-methyl- | 000095-48-7 | 0.5% | | 0.7% |
| Phenol, 2-methyl-5-(1-methylethyl)- | 000499-75-2 | | 1.2% | |
| Phenol, 2-propyl- | 000644-35-9 | | 10.0% | |
| Phenol, 3,4-dimethyl- | 000095-65-8 | | 2.1% | |
| Phenol, 3-ethyl- | 000620-17-7 | | 3.8% | 0.0% |
| Phenol, 4-(1-methylpropyl)- | 000099-71-8 | 0.1% | | 0.1% |
| Phenol, 4-(2-propenyl)- | 000501-92-8 | | 0.6% | 0.3% |
| Phenol, 4-ethyl-2-methoxy- | 002785-89-9 | 1.2% | 1.6% | 0.6% |
| Phenol, 4-ethyl-3-methyl- | 001123-94-0 | | 0.6% | 0.1% |
| p-Cresol | 000106-44-5 | 0.7% | | 0.1% |
| p-Cresol | 000108-39-4 | | 0.5% | |
| trans-Isoeugenol | 005932-68-3 | | 2.0% | 3.2% |

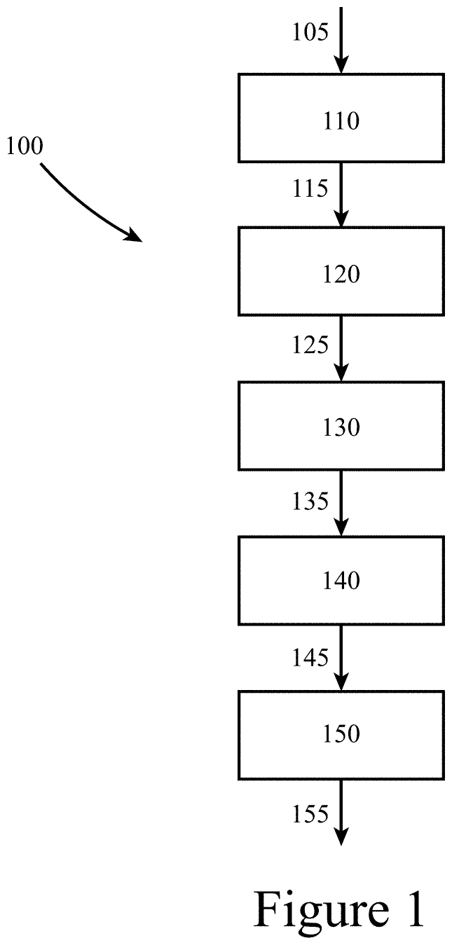

FIG. 1 illustrates a method 100 for producing one or more compounds having pesticidal activity, according to some embodiments of the present disclosure. As shown in this exemplary method 100, a biomass stream 105 may be directed to a step for pyrolyzing 110 at least a portion of the biomass stream 105 to produce a crude oil stream 115 containing the compound having pesticidal activity. Example of materials that may be included in a biomass stream 105 include at least one of a softwood, a hardwood, a grass, an agricultural waste, a municipal waste, and/or a forest residue. In some embodiments of the present disclosure, a forest residue may include at least one of a residue from pine. As described herein, the pyrolyzing 110 may be performed by at least one of fast pyrolysis, in situ catalytic fast pyrolysis, and/or ex situ catalytic fast pyrolysis. Other biomass streams 105 that can be utilized include lignin extracted from biomass including lignin mixtures of Kraft-lignin and/or organosolve lignin, and/or mixtures of extracted lignin with other biomass including softwoods, hardwoods, grasses, and/or wastes.

In some embodiments of the present disclosure, the pyrolyzing 110 to produce a crude oil stream 115 may be completed by at least one of fast pyrolysis process and/or catalytic fast pyrolysis process. Catalytic fast pyrolysis (CFP), which includes both pyrolysis to produce pyrolysis vapors and the catalytic upgrading of the pyrolysis vapors to produce the crude oil 115, may be completed in a single unit operation (i.e. in-situ CFP) and/or in a first unit operation for performing the pyrolysis, followed by a second unit operation for performing the upgrading of the pyrolysis vapors (i.e. ex-situ CFP) to the crude oil stream 115. In some embodiments of the present disclosure, for the example of in-situ CFP, the pyrolyzing and upgrading may be performed in at least one of a single fixed bed reactor, a single fluidized bed reactor, and/or a single entrained flow reactor. The pyrolyzing and upgrading in an in-situ CFP process may be performed at a temperature between about 350° C. and about 800° C., inclusively, or at a temperature between about 500° C. and about 600° C., inclusively.

For the example of ex-situ CFP, the pyrolyzing may be performed in a first reactor to produce pyrolysis vapors which are subsequently upgraded in a second reactor to produce the crude oil stream 115. In some embodiments of the present disclosure, for the case of ex-situ CFP, the pyrolysis of a biomass stream 105 to produce pyrolysis vapors may be completed in a first reactor that includes at least one of a first fixed bed reactor, a first fluidized bed reactor, and/or an first entrained flow reactor, where the pyrolysis vapors are subsequently upgraded in a second reactor that includes at least one of a second fixed bed reactor, a second fluidized bed reactor, and/or a second entrained flow reactor to produce the crude oil 115. In some embodiments of the present disclosure, for the example of ex-situ CFP, the pyrolyzing of the biomass stream 105 in a first reactor may be performed at a temperature between about 350° C. and about 800° C., inclusively, or between about 500° C. and about 600° C., inclusively, resulting in the forming of pyrolysis vapors. Subsequent to the pyrolyzing, the pyrolysis vapors may be upgraded in a second reactor at a temperature between about 400° C. and about 500° C., inclusively.

Referring again to FIG. 1, a crude oil stream 115 produced by the pyrolyzing 110 of a biomass stream 105 may be directed to an initial separating 120, resulting in two or more separate streams, including an oil stream 125 that includes the compound having pesticidal activity. An initial separating 120 of a crude oil stream 115 may be performed by at least one of a distillation process, an extraction process, a chromatography process, an adsorption process, a membrane process, and/or an absorption process. In some embodiments of the present disclosure, the initial separating 120 of a crude oil stream 115 to produce an oil stream 125 including the compound having pesticidal activity may be performed by a distillation process that includes a first distillation column. Such a distillation column may be operated in batch mode and/or continuous mode. In some embodiments of the present disclosure, a first distillation column may be operated at a pressure between about 0.001 atm and about 10 atm, or between about 0.01 atm and about 1 atm.

In some embodiments of the present disclosure, a first distillation column of an initial separating 120 of a crude oil stream 115 into multiple streams including an oil stream 125 including the compound having pesticidal activity may have between 1 theoretical plate and 200 theoretical plates. A first distillation column may be operated at a reflux ratio between zero and about 100. In some embodiments of the present disclosure, a first distillation column may be operated at a temperature between about 20° C. and about 400° C. In some embodiments of the present disclosure, a first distillation column of an initial separating 120 may be operated at an overhead temperature between about 100° C. and about 300° C., inclusively, or between about 100° C. and about 115° C., inclusively, or between about 115° C. and about 180° C., inclusively, or between about 180° C. and about 210° C., inclusively, or between about 210° C. and about 230° C., inclusively, or between about 230° C. and about 250° C., inclusively, or between about 250° C. and about 270° C., inclusively. In some embodiments of the present disclosure, the overhead temperature of a first distillation column for an initial separating 120 may correspond to a steady-state temperature for a first distillation column operated in a continuous mode, and/or the overhead temperature may correspond to a dynamic temperature changing with time due to the first distillation column being operated in a batch mode.

Referring again to FIG. 1, in some embodiments of the present disclosure, a first distillation column (not shown) of a first separating 120 of a crude oil stream 115 may result in at least four streams, including the oil stream 125 including the compound having pesticidal activity.

For example, a crude oil stream 120 may be fed to a first distillation column resulting in the forming of a first stream (not shown) exiting overhead of the first distillation column where the first stream includes components having relatively low boiling points and/or molecular weights (e.g., acetic acid, water, propanoic acid, and/or toluene), and a second stream (not shown) exiting the bottom of the first distillation where the second stream includes components having relatively high boiling points and/or high molecular weights (e.g., phenol, cresol, guaiacol, 2,4-dimethy phenol, and/or 2-propyl phenol, syringol). In addition, in this example, a first distillation column may also produce a third stream exiting the column at a location between the bottom and the overhead, where the third stream includes components having boiling points and/or molecular weights intermediate to those of the components contained in the first stream and the second stream, the overheads stream and the bottoms stream, respectively. Among other things, such a third stream may include one or more ketones (e.g., cyclopentanone and/or 2-cyclopenten-1-one). In addition, in this example, a first distillation column may also produce a fourth stream, the oil stream 125, exiting the column at a location between the first stream and the third stream, where the fourth stream includes components having boiling points and/or molecular weights intermediate to those of the components contained in the first stream and the third stream, the overheads stream and the stream containing a ketone, respectively. Importantly, such a fourth stream, the oil stream 125, includes one or more compounds having pesticidal activity.

Referring again to FIG. 1, in some embodiments of the present disclosure, a method 100 may direct an oil stream 125 that includes a compound having pesticidal activity to an extracting 130 step, where the extracting 130 results in the formation of a purified oil stream 135 containing the compound having pesticidal activity. In some embodiments of the present disclosure, the extracting 130 may be performed by contacting the oil stream 125 with a liquid, which may include a polar solvent, such as at least one of water, ethyl acetate, and/or butyl acetate, resulting in the transfer of one or more compounds, including the compound having pesticidal activity, into the liquid, thereby forming the purified oil stream 135. For the example of a water-containing extractant, the water may be maintained at a pH between about 7 and about 14, and after the extracting, the water containing the active compound may be adjusted to a pH that is approximately neutral or acidic for additional extraction by another solvent. In some embodiments of the present disclosure, the extracting unit may be comprised of a hollow fiber membrane contactor. In some embodiments of the present disclosure, the extracting 130 may be performed by contacting the oil stream 125 with a selective membrane resulting in the transfer of one or more compounds, including the compound having pesticidal activity, into a liquid or vapor phase on the other side of the selective membrane, thereby forming the purified oil stream 135.

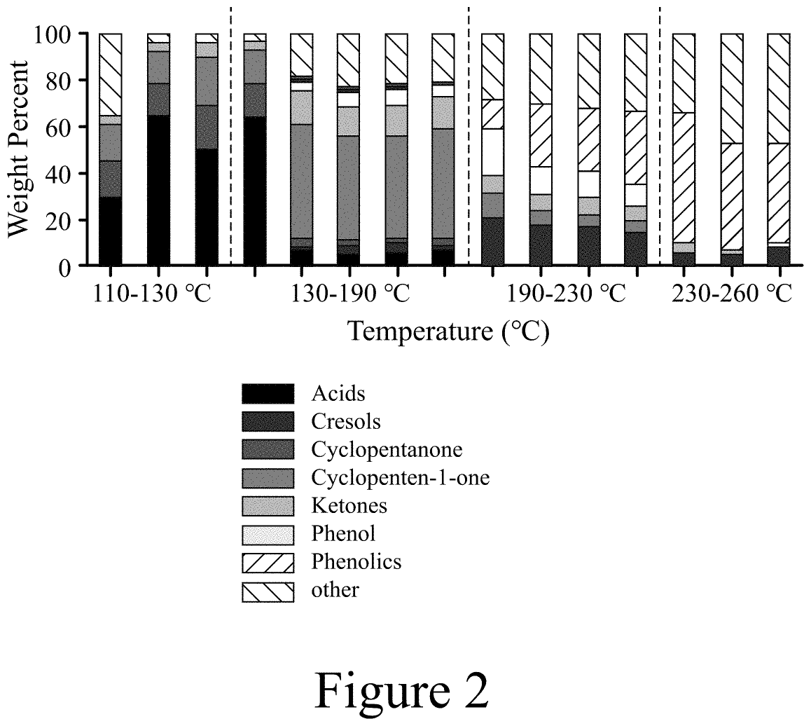

Referring again to FIG. 2, in some embodiments of the present disclosure, a method 100 may direct an oil stream 125 that includes a compound having pesticidal activity to a chromatographic step, where the chromatographic is used in place of the extracting 130 step, or in addition to the extracting 130 step, resulting in the formation of a purified oil stream 135 containing the compound having pesticidal activity. In some embodiments of the present disclosure, an oil stream 125 may be made to flow over selectively adsorptive beads constructed of at least one of a metal, a ceramic, a glass, and/or a polymer. In some embodiments of the present disclosure, a chromatographic separation may include a simulated moving bed unit operation having an appropriately selective adsorbing packing.

Referring again to FIG. 1, at least one of the oil stream 125 and/or a purified oil stream 135 may then be directed to a second separating 140 step, resulting in the forming of a product stream 145 containing the active compound. A second separating 140 of an oil stream 125 and/or a purified oil stream 135 may be performed by at least one of a distillation process, an extraction process, a chromatography process, an adsorption process, and/or an absorption process. In some embodiments of the present disclosure, a second separating 140 of an oil stream 125 and/or a purified oil stream 135 to produce an product stream 145 including the active compound may be performed by a distillation process that includes a second distillation column. Such a distillation column may be operated in batch mode and/or continuous mode. In some embodiments of the present disclosure, a second distillation column may be operated at a pressure between about 0.001 atm and about 10 atm, or between about 0.01 atm and about 1 atm.

In some embodiments of the present disclosure, a second distillation column of a second separating 140 of an oil stream 125 and/or a purified oil stream 135 into at least a product stream 145 containing the active compound may have between 1 theoretical plate and 200 theoretical plates. A second distillation column may be operated at a reflux ratio between zero and about 100. In some embodiments of the present disclosure, a second distillation column may be operated at a temperature between about 20° C. and about 400° C. In some embodiments of the present disclosure, a second distillation column of a second separating 140 may be operated at an overhead temperature between about 100° C. and about 300° C., inclusively, or between about 100° C. and about 115° C., inclusively, or between about 115° C. and about 180° C., inclusively, or between about 180° C. and about 210° C., inclusively, or between about 210° C. and about 230° C., inclusively, or between about 230° C. and about 250° C., inclusively, or between about 250° C. and about 270° C., inclusively. In some embodiments of the present disclosure, the overhead temperature of a second distillation column for a second separating 140 may correspond to a steady-state temperature for a second distillation column operated in a continuous mode, and/or the overhead temperature may correspond to a dynamic temperature changing with time due to the second distillation column being operated in a batch mode.

Referring again to FIG. 1, in some embodiments of the present disclosure, a product stream 145 resulting from a second separating 140 step may be directed to a crystallizing 150 step, resulting in the forming of a purified product stream 155 that includes the active compound. Steam 145 can be dissolved in a solvent (e.g. toluene, xylene, and/or chloroform) by heating the solution to the boiling point of the solvent, which may be, for example, between about 20° C. and about 100° C. Recrystallization can occur by cooling at specified cooling rates the solution to form solid product. The solution can also be precipated through the addition of a counter solvent (e.g. water, methanol, and/or ethanol) to form precipitated solid product. The solid material can be filtered from the raffinate and dried. Solid products can be further purified using zone recrystallization in which a spatial zone is heated selectively, typically in a bottom to top manner so that remaining impurities are concentrated in a zone remaining at the top of the purified crystalline product. In some embodiments of the present disclosure, a crystallizing 150 step may be performed using one or more other unit operations; e.g., a distillation process, an extraction process, a chromatography process, an adsorption process, and/or an absorption process. These unit operations may be used in addition to a crystallizing process or in place of a crystallizing process.

FIG. 2 illustrates weight percentages for compounds and groups of compounds resulting from the fractionation of CFP oil using vacuum distillation. The general classes of compounds and individual compounds include, acids, cresols, cyclopentanone, cyclopentene-1-one, ketones, phenol, phenolics, in addition to other compounds. In some embodiments of the present disclosure, vacuum distillation may be performed in batch mode, continuous mode, and/or semi-batch mode. Vacuum distillation may be performed at any pressure below atmospheric pressure (760 Torr), at a pressure less than 500 Torr, or at a pressure less than 50 Torr. Distillate fractions were collected for different temperature ranges and the plot shows replicates for each of these ranges. FIG. 2 demonstrates that compounds and/or groups of compounds may be separated from each other, resulting in purified fractions of compounds and/or groups of compounds. Although vacuum distillation was used to produce the data shown in FIG. 2, other separation methods may be used to separate pesticide active compounds from pyrolysis bio-oil mixtures. Some suitable separation methods are liquid-liquid extraction, membrane separations, recrystallization, precipitation, and/or other distillation methods, including reactive distillation.

Different fractions, e.g. different compounds at different concentrations, may have different pesticide activity. In some embodiments of the present disclosure, a biomass-derived pesticide may include an active compound that includes at least one of a ketone, a phenol, and/or a cresol. Specific examples of active compounds of a biopesticide, according to some embodiments of the present disclosure include,

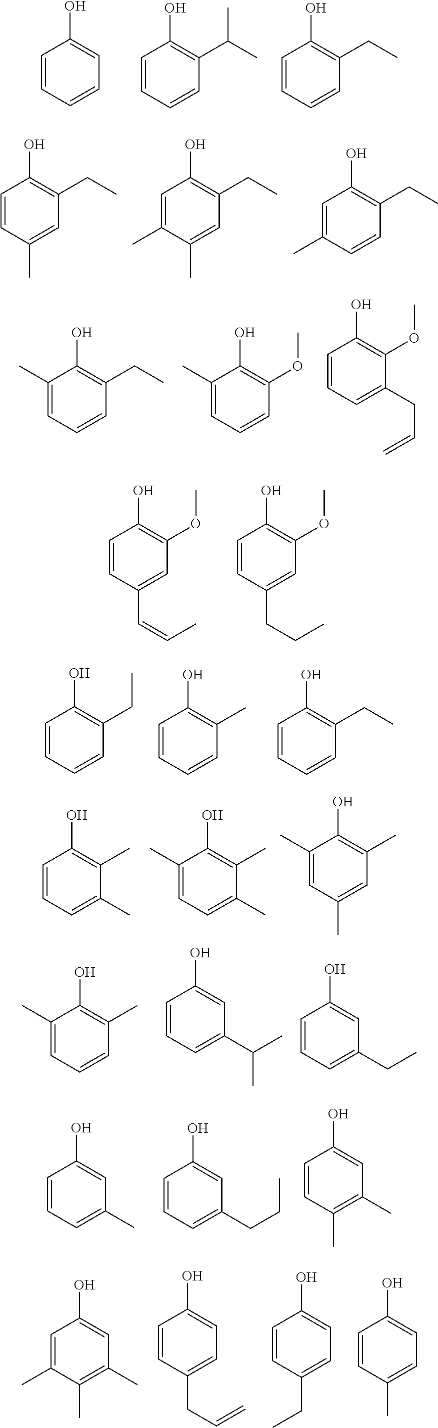

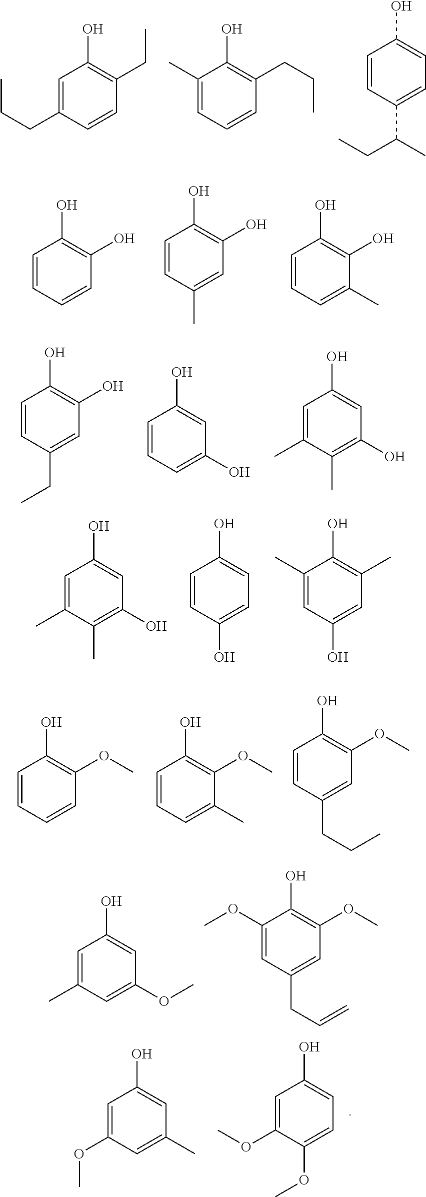

Some example compounds having pesticidal activity, according to some embodiments of the present disclosure, include at least one of 2-ethyl-5-n-propylphenol, 2-methyl-6-propylphenol, 2,5-diethylphenol, phenol, 2-(1-methylethyl)-phenol, 2-ethyl-phenol, 2-ethyl-4-methyl-phenol, 2-ethyl-4,5-dimethyl-phenol, 2-ethyl-5-methyl-phenol, 2-ethyl-6-methyl-phenol, 2-methoxy-phenol, 2-methoxy-3-(2-propenyl)-phenol, 2-methoxy-4-(1-propenyl)-phenol, (Z)-phenol, 2-methoxy-4-propyl-phenol, 2-methyl-phenol, 2-methyl-5-(1-methylethyl)-phenol, 2-propyl-phenol, 2,3-dimethyl-phenol, 2,3,6-trimethyl-phenol, 2,4,6-trimethyl-phenol, 2,6-dimethyl-phenol, 3-(1-methylethyl)-phenol, 3-ethyl-phenol, 3-methyl-phenol, 3-propyl-phenol, 3,4-dimethyl-phenol, 3,4,5-trimethyl-phenol, 4-(2-propenyl)-phenol, 4-ethyl-phenol, 4-methyl-benzenediol, and/or any other alkyl-benzenediol.

As a biopesticide, it was found that an alkylated phenol fraction, collected during a batch distillation experiment operated at about 30 Torr, collected during a temperature range between about 230° C. and about 250° C., had a higher lethality than the phenol fraction collected over a temperature range between about 185° C. and about 230° C. The improved activity is due to the alkyl functional groups of the phenol rings.

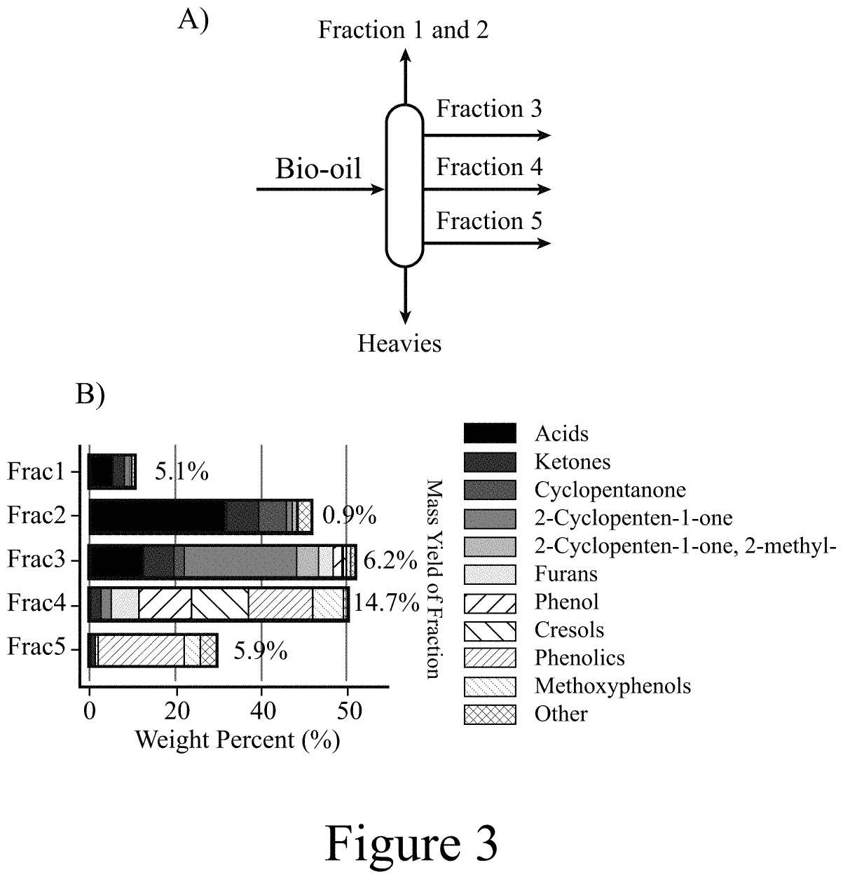

Panel A of FIG. 3 illustrates an exemplary process/method for producing, among other things, biopesticides (i.e. compounds having pesticidal activity), according to some embodiments of the present disclosure. As shown in Panel A of FIG. 3, bioinsecticides may be obtained from the fractionation of a CFP oil via distillation at about 30 Torr. Experimentally, each pathway begins with the fractional distillation of the CFP oil where various fractions are separated from the rest of the oil. For example, a CFP oil was fractioned into five fractions: aqueous (fraction 1, between about 110° C. and about 115° C.), acids (fraction 2, between about 115° C. and about 130° C.), cyclic ketones (fraction 3, between about 130° C. and about 185° C.), simple phenols (fraction 4, between about 185° C. and about 230° C.), and alkylated phenols (fraction 5, between about 230° C. and about 250° C.). Each of these fractions were tested for pesticidal activity. Part B of FIG. 3 illustrates the weight percent of each fraction relative to the starting mass loaded into the distillation column as well as the yields of each fraction; 5.1%, 0.9%, 6.2%, 14,7%, and 5.9% for Fractions 1, 2, 3, 4, and 5, respectively. These data show that as the temperature was increased the distribution of compounds changed from relatively low molecular weight acids, ketones, cyclopentenes, and furans, to higher molecular weight phenol, cresols, phenolics, and methoxyphenols.

The activity of a CFP derived bio-insecticide may be linked to the chemical nature of a feedstock, such as lignocellulosic biomass, and multiple components of a bio-oil may exhibit pesticidal activity or may act in a synergistic manner so that the overall yield of the biopesticide product is increased. This may result in a substantial volume of product with significantly higher value than when pyrolysis oil is used as a fuel.

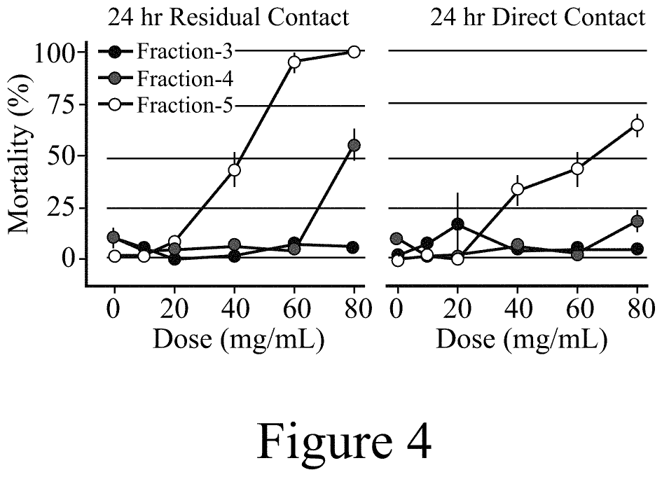

To test the viability of CFP derived bio-insecticides fraction 3 (cyclic ketones), fraction 4 (simple phenols), and fraction 5 (alkyl phenols), see FIG. 3, were tested for activity using adult spotted wing Drosophila (Drosophila suzukii) as a model insect. The results are illustrated in FIG. 4, which demonstrates the general trend that higher temperature fractions, corresponding to higher molecular weight compounds demonstrated higher mortality percentages, e.g. lower LC₅₀ values. Following a preliminary range-finding experiment, concentrations of 80 mg/ml, 60 mg/ml, 40 mg/ml, 20 mg/ml 10 mg/ml and 0 mg/ml of each of the three fractions were tested, with the balance of material made up of 70% acetone. Six replicates were performed for each dose/application condition. Insects were collected from standing laboratory colonies established from wild flies caught in 2018 and reared on a standard Drosophila diet. For each dose/replicate 5 males and 5 females were knocked out with CO₂ and stored at room temperature before use in trials. Pesticide applications were made to test subjects directly or to 9 cm petri dishes used in residual contact trials. 1.5 ml of the appropriate dose was loaded into a Potter spray tower and applied to flies on a 9 cm petri dish (direct mortality test) or to a petri dish to which flies were added after dishes were dried in a fume hood (residual mortality test). The Potter spray tower was rinsed with 2 ml of 95% acetone between each tested concentration of biopesticide. Flies in the residual mortality trial were provided with 1 ml of fly diet and left in the treated area for the duration of the study. Fly mortality and morbidity were evaluated at 0, 2, 8, 24 hours after direct application or placement into the treated dish.

Data for the results of the direct contact assay by dose at 24 hours are illustrated in FIG. 4 (right). Fractions 3 and 4 did not exceed a mean 24 hour mortality of over 10% at any of the tested doses. Fraction 5 provided 24 hour mortalities of 43±9%, 43±9%, and 64±5% for doses of 40, 60 and 80 mg/mL. Data for the results of the residual contact assay by dose at 24 hours are presented in FIG. 4 (left). Fractions 3 and 4 did not exceed a mean 24 hour mortality of over 20% at any of the tested doses except for 80 mg/mL for fraction 4, which had a mortality of 55±8% mortality. Fraction 5 provided 24 hour mortalities of 43±9%, 95±4%, and 100±0% for doses of 40, 60 and 80 mg/mL.

These experimental results suggest, that in some embodiments of the present disclosure, and for these experimental conditions, that fraction 5 has a high potential for development into an insecticide with residual, contact control at rates of 60/mg/ml and above. The experimental work here found that the highly alkylated phenols exhibited the greatest pesticidal activity. In some embodiments of the present disclosure, one or more active compounds from fraction 5 may be combined with pipronyl butoxide, a low cost pesticide synergist. An additional benefit of this bio-insecticide is the potential for native soil flora to metabolize the compounds, since the chemical functionality is similar to lignin type compounds. This may reduce the persistence of the bio-insecticide in the environment.

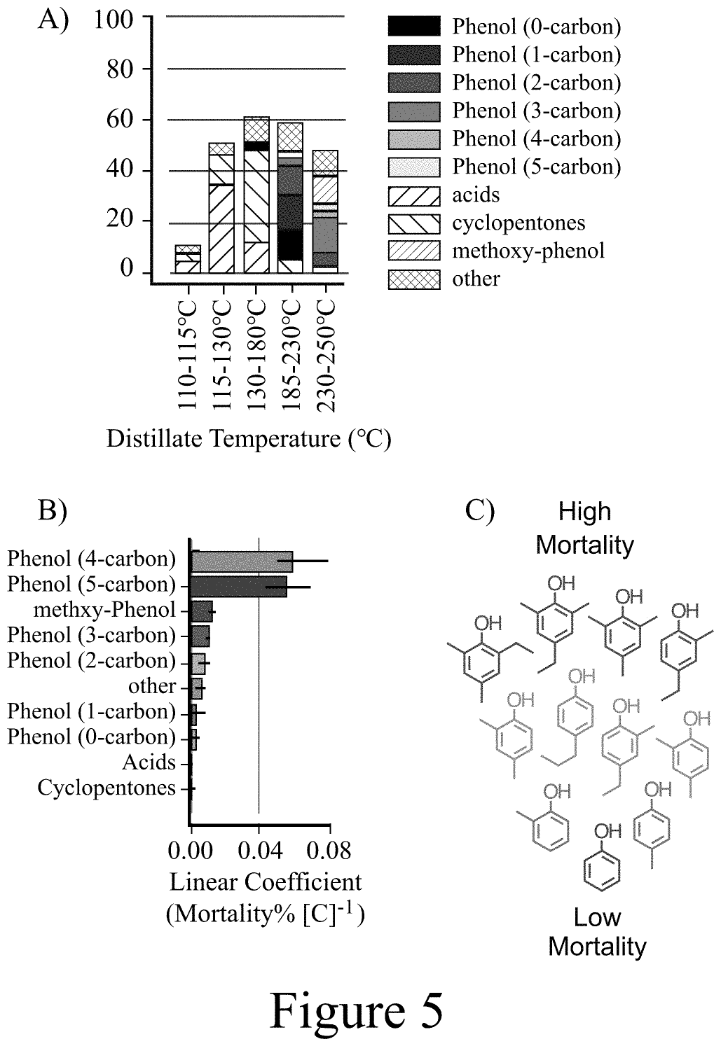

Panel A of FIG. 5 illustrates a compositional analysis of CFP fractions with chemical groupings, Panel B of FIG. 5 illustrates linear correlation coefficients as a function of chemical sub-group, and Panel C of FIG. 5 illustrates a general structure-function relationship for increased mortality, according to some embodiments of the present disclosure. Panel A of FIG. 5 illustrates the composition of streams resulting from batch mode distillation to produce active ingredients. Fractions 130-185° C., 185-230° C., and 230-250° C. were used in dose response curves and fraction 230-250° C. showed the greatest lethality against Spotted Wing Drosophilia in direct and residual contact assays, as illustrated in FIG. 4. Ordinary least squared regression was used to relate mortality and dose of each subgroup through linear coefficients. Linear coefficients, shown in Panel B of FIG. 5, reveal that increasing degree of alkylation or alkyoxylation tends to correlate with increased activity.

Table 2 summarizes mortality data of two organisms, the Cabbage Lopper and the Beet Armyworm, of compounds derived from a first pyrolysis oil, referred to herein as “Oil A”. Table 3 summarizes mortality data of two organisms, the Cabbage Lopper and the Beet Armyworm, of compounds derived from a second pyrolysis oil, referred to herein as “Oil B”. Production of the fraction proceeded through conversion of biomass via fast pyrolysis or catalytic fast pyrolysis. The resulting bio-oil as was distilled via vacuum distillation into active fractions.

TABLE 2
Mortality Rates from Active Compounds Derived from Oil A

| | | Uncorrected | Uncorrected |
|---|---|---|---|
| | Day 4 | Mortality @ | Mortality @ |
| Fast Pyrolysis Active Fractions | LC50 | 10 mg/mL | 40 mg/mL |
| 7451-052-04 against Cabbage Lopper | 4.3 mg/mL | 93.75 | 100.00 |
| 7451-052-04 against Beet Armyworm | 7.4 mg/mL | 87.5 | 100.00 |

TABLE 3
Mortality Rates from Active Compounds Derived from Oil B

| | | Uncorrected | Uncorrected |
|---|---|---|---|
| | Day 4 | Mortality @ | Mortality @ |
| Catalytic Fast Pyrolysis Active Fractions | LC50 | 10 mg/mL | 40 mg/mL |
| Pt/TiO₂ 230-250 against Cabbage Lopper | 8.5 mg/mL | 37.50 | 100.00 |
| Pt/TiO₂ 230-250 against Beet Armyworm | 6.7 mg/mL | 54.17 | 100.00 |
| Pt/TiO₂ 250-270 against Cabbage Lopper | 5 mg/mL | 83.33 | 100.00 |
| Pt/TiO₂ 250-270 against Beet Armyworm | 5.8 mg/mL | 100.00 | 95.83 |

Table 4 provides a typical composition for a catalytic fast pyrolysis oil, Pt/TiO₂.

TABLE 4
Oil A or B Composition (weight percentages)

| Compound | Wt % |
|---|---|
| 2-Pentanone | 0.274% |
| 2-Propanone, 1-hydroxy- | 0.121% |
| Toluene | 0.068% |
| 3-Penten-2-one, (E)- | 0.144% |
| 2-Hexanone | 0.067% |
| Cyclopentanone | 1.127% |
| Cyclopentanone, 2-methyl- | 0.381% |
| Furfural | 0.586% |
| 2-Cyclopenten-1-one | 2.104% |
| Furan, 2-ethyl- | 0.259% |
| 2(3H)-Furanone, 5-methyl- | 0.398% |
| Cyclohexanone | 0.108% |
| Cyclopentanone, 2-ethyl- | 0.129% |
| 2-Cyclopenten-1-one, 2-methyl- | 1.327% |
| Ethanone, 1-(2-furanyl)- | 0.447% |
| 2-Cyclopenten-1-one, 2-hydroxy- | 0.160% |
| Phenol | 3.122% |
| 2-Furancarboxaldehyde, 5-methyl- | 0.643% |
| Indane | 0.101% |
| 2-Cyclopenten-1-one, 3-methyl- | 2.243% |
| Indene | 0.079% |
| Phenol, 2-methyl- | 1.370% |
| 2(5H)-Furanone, 3-methyl- | 0.266% |
| Phenol, 3-methyl- | 2.397% |
| 1H-Indene, 2,3-dihydro-5-methyl- | 0.141% |
| Phenol, 2-methoxy- | 0.640% |
| 1H-Indene, 2,3-dihydro-5-methyl- | 0.087% |
| 2-Cyclopenten-1-one, 3-ethyl- | 0.197% |
| Phenol, 2-ethyl- | 0.482% |
| Phenol, 2,4-dimethyl- | 0.898% |
| 4-Methyl-5H-furan-2-one | 0.315% |
| Phenol, 4-ethyl- | 0.861% |
| Phenol, 3-ethyl- | 1.629% |
| Phenol, 2,5-dimethyl- | 0.436% |
| Naphthalene | 0.117% |
| Phenol, 2,3,5-trimethyl- | 0.123% |
| Phenol, 2-methoxy-4-methyl- | 0.816% |
| Cyclohexene, 1-ethyl-6-ethylidene- | 0.142% |
| Benzofuran, 2,3-dihydro | 0.228% |
| Phenol, 2-ethyl-6-methyl- | 0.696% |
| Benzofuran, 2,3-dihydro- | 0.131% |
| 1,3-Cyclopentadiene, 5,5-dimethyl-2-propyl- | 1.521% |
| Phenol, 3-ethyl-5-methyl- | 0.703% |
| Phenol, 4-(2-propenyl)- | 0.397% |
| Phenol, 2-ethyl-4,5-dimethyl- | 0.092% |
| Phenol, 2,4,6-trimethyl- | 0.084% |
| Phenol, 4-ethyl-2-methoxy- | 0.434% |
| 4-Hydroxy-3-methylacetophenone | 0.182% |
| 2-Methyl-6-propylphenol | 0.088% |
| Naphthalene, 2-methyl- | 0.277% |
| Phenol, diethyl- | 0.351% |
| 2-Methyl-6-propylphenol | 0.651% |
| Phenol, 4-(2-propenyl)- | 0.399% |
| 2-Methoxy-4-vinylphenol | 1.063% |
| Phenol, 2-(1,1-dimethylethyl)-5-methyl- | 0.391% |
| Benzaldehyde, ethyl- | 0.616% |
| Phenol, 4-(2-propenyl)- | 1.051% |
| Phenol, 2-methoxy-3-(2-propenyl)- | 1.023% |
| 1H-Inden-5-ol, 2,3-dihydro- | 1.199% |
| 2-Ethyl-5-n-propylphenol | 0.235% |
| 1H-Indenol | 0.539% |
| 1,3-Cyclopentadiene, 5,5-dimethyl-1,2- | 0.324% |
| Dipropyl- | |
| Phenol, 2-methoxy-4-(1-propenyl)- | 0.395% |
| 2-Allyl-4-methylphenol | 0.206% |
| 6-Methyl-4-indanol | 0.442% |
| 1,3-Cyclopentadiene, 5,5-dimethyl-1,2- | 0.157% |
| Dipropyl- | |
| 6-Methyl-4-indanol | 0.297% |
| Phenol, 2-methoxy-4-(1-propenyl)- | 1.646% |
| 6-Methyl-4-indanol | 0.368% |
| Benzaldehyde, 3-hydroxy-4-methoxy- | 0.513% |
| 2-Propyn-1-ol, 3-(4-methylphenyl)- | 0.127% |
| Benzene, 1,2-diethyl-3,4-dimethyl- | 0.255% |
| Benzene, 1-(1,1-dimethylethyl)-3,5-dimethyl- | 0.430% |
| 1-Naphthalenol | 0.138% |
| Benzofuran, 2-ethenyl- | 0.145% |
| Phenol, 4-ethyl-2-methoxy- | 0.266% |
| 1,6-Anhydro-.beta.-D-glucopyranose | 0.301% |
| (levoglucosan) | |
| 1-Naphthalenol, 2-methyl- | 0.254% |
| Benzeneacetic acid, 4-hydroxy-3-methoxy- | 0.260% |
| 1-Naphthalenol, 2-methyl- | 0.199% |
| 4-Hydroxy-2-methoxycinnamaldehyde | 0.267% |
| Phenanthrene, 1-methyl-7-(1-methylethyl)- | 0.064% |

Whether or not a compound described herein is “bioderived” may be determined by analytical methods. Using radio carbon and isotope ratio mass spectrometry analysis, the bio-based content of materials can be determined. ASTM International, formally known as the American Society for Testing and Materials, has established a standard method for assessing the biobased content of carbon-containing materials. The ASTM method is designated ASTM-D6866. The application of ASTM-D6866 to derive a “biobased content” is built on the same concepts as radiocarbon dating, but without use of the age equations. The analysis is performed by deriving a ratio of the amount of radiocarbon (14C) in an unknown sample to that of a modern reference standard. The ratio is reported as a percentage with the units “pMC” (percent modern carbon). If the material being analyzed is a mixture of present-day radiocarbon and fossil carbon (containing no radiocarbon), then the pMC value obtained correlates directly to the amount of biomass material present in the sample. Thus, ASTM-D866 may be used to validate that the compositions described herein are and/or are not derived from renewable sources.

### Composition Examples

Example 1. A composition comprising: a compound comprising the structure

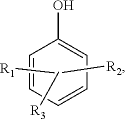

wherein: R₁ comprises at least one of a hydrogen atom, a hydroxyl group, a first alkoxy group, or a first hydrocarbon, R₂ comprises at least one of a hydrogen atom, a hydroxyl group, a second alkoxy group, or a second hydrocarbon, R₃ comprises at least one of a hydrogen atom, a hydroxyl group, a third alkoxy group, or a third hydrocarbon, and the composition has an LC₅₀ of less than about 150 mg compound/mL composition for an organism comprising the Colorado Potato Beatle (Leptinotarsa decemlineata).

Example 2. The composition of Example 1, wherein the compound is bioderived as determined by ASTM-D6866.

Example 3. The composition of either Example 1 or Example, wherein the compound is derived from an oil formed by catalytic fast pyrolysis of biomass.

Example 4. The composition of any one of Examples 1-3, wherein the first hydrocarbon comprises between 1 and 5 carbon atoms.

Example 5. The composition of any one of Examples 1-4, wherein the second hydrocarbon comprises between 1 and 5 carbon atoms.

Example 6. The composition of any one of Examples 1-5, wherein the third hydrocarbon comprises between 1 and 5 carbon atoms.

Example 7. The composition of any one of Examples 1-6, wherein at least one of the first hydrocarbon, the second hydrocarbon, or the third hydrocarbon comprises between 1 and 5 carbon atoms.

Example 8. The composition of any one of Examples 1-7, wherein the first alkoxy group comprises between 1 and 5 carbon atoms.

Example 9. The composition of any one of Examples 1-8, wherein the second alkoxy group comprises between 1 and 5 carbon atoms.

Example 10. The composition of any one of Examples 1-9, wherein the third alkoxy group comprises between 1 and 5 carbon atoms.

Example 11. The composition of any one of Examples 1-10, wherein at least one of the first alkoxy group, the second alkoxy group, or the third alkoxy group comprises between 1 and 5 carbon atoms.

Example 12. The composition of any one of Examples 1-11, wherein the compound comprises at least one of a trimethyl phenol, an ethyl-methyl phenol, a 4-carbon, a 5-carbon phenol, a dimethyl phenol, an ethyl phenol, a propyl phenol, or a methoxy phenol.

Example 13. The composition of any one of Examples 1-12, wherein the 4-carbon phenol comprises 2-methyl-5-(1-methylethyl).

Example 14. The composition of any one of Examples 1-13, wherein the 5-carbon phenol comprises 2-ethyl-5-n-propyl phenol.

Example 15. The composition of any one of Examples 1-14, wherein the compound comprises 4-methyl-1,2-benzenediol.

Example 16. The composition of any one of Examples 1-15, wherein the compound further comprises a creosol.

Example 17. The composition of any one of Examples 1-16, wherein the compound further comprises 4-ethylcatechol.

Example 18. The composition of any one of Examples 1-17, wherein the compound further comprises 2,6-dimethyl-1,4-benzenediol.

Example 19. The composition of any one of Examples 1-18, wherein the compound comprises at least one of 4-methyl-1,2-benzenediol, a creosol, 4-ethylcatechol, 2,6-dimethyl-1,4-benzenediol, 2-methoxy-phenol, 4-hydroxy-3-methoxy-benzoic acid, 3-methyl-1,2-benzenediol, 4-ethyl-2-methoxy-phenol, 3,6-dimethyl-benzo[B]thiophene, 3,4-dimethoxy-phenol, p-cresol, 2,4-dimethyl-phenol, 2-methyl-phenol, hydroquinone, 4,5-dimethyl-1,3-benzenediol, 2-methoxy-4-propyl-phenol, or phenol.

Example 20. The composition of any one of Examples 1-19, wherein the compound comprises at least one of 2-ethyl-5-n-propylphenol, 2-methyl-6-propylphenol, 2,5-diethylphenol, phenol, 2-(1-methylethyl)-phenol, 2-ethyl-phenol, 2-ethyl-4-methyl-phenol, 2-ethyl-4,5-dimethyl-phenol, 2-ethyl-5-methyl-phenol, 2-ethyl-6-methyl-phenol, 2-methoxy-phenol, 2-methoxy-3-(2-propenyl)-phenol, 2-methoxy-4-(1-propenyl)-phenol, (Z)-phenol, 2-methoxy-4-propyl-phenol, 2-methyl-phenol, 2-methyl-5-(1-methylethyl)-phenol, 2-propyl-phenol, 2,3-dimethyl-phenol, 2,3,6-trimethyl-phenol, 2,4,6-trimethyl-phenol, 2,6-dimethyl-phenol, 3-(1-methylethyl)-phenol, 3-ethyl-phenol, 3-methyl-phenol, 3-propyl-phenol, 3,4-dimethyl-phenol, 3,4,5-trimethyl-phenol, 4-(2-propenyl)-phenol, 4-ethyl-phenol, 4-methyl-benzenediol, or any other alkyl-benzenediol.

Example 21. The composition of any one of Examples 1-21, wherein the LD₅₀ is effective for the organism further comprising at least one of the Cabbage Looper (Trichoplusia ni), the Beet Armyworm (Spodoptera exigua), or the Spotted Wing Drosophila (Drosophila suzukii).

Example 22. The composition of any one of Examples 1-21, wherein the organism is in a stage of growth comprising at least one of a larval stage, a pupal stage, or an adult stage.

Example 23. The composition of any one of Examples 1-22, further comprising: a solvent, wherein: the compound is mixed with the solvent at a concentration equal to the LC₅₀.

Example 24. The composition of any one of Examples 1-23, wherein the solvent comprises a polar solvent.

Example 25. The composition of any one of Examples 1-24, wherein the polar solvent is water.

Method of Making Examples:

Example 1. A method comprising: a second separating of a compound comprising the structure

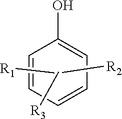

from an oil stream, wherein: R₁ comprises at least one of a hydrogen atom, a hydroxyl group, a first alkoxy group, or a first hydrocarbon, R₂ comprises at least one of a hydrogen atom, a hydroxyl group, a second alkoxy group, or a second hydrocarbon, R₃ comprises at least one of a hydrogen atom, a hydroxyl group, a third alkoxy group, or a third hydrocarbon, and the composition has an LC₅₀ of less than about 150 ml compound/kg composition for an organism comprising the Colorado Potato Beatle (Leptinotarsa decemlineata).

Example 2. The method of Example 1, further comprising, prior to the second separating: an initial separating of the oil stream and a secondary stream from a crude oil stream, wherein: the crude oil stream comprises the compound derived from pyrolysis of a biomass stream.

Example 3. The method of either Example 1 or Example 2, wherein the second stream comprises a ketone.

Example 4. The method of any one of Examples 1-3, further comprising, prior to the initial separating, producing the crude oil stream by pyrolyzing the biomass in at least one of a fast pyrolysis process or a catalytic fast pyrolysis process.

Example 5. The method of any one of Examples 1-4, wherein the second separating is performed by at least one of a distillation process, an extraction process, a chromatography process, an adsorption process, or an absorption process.

Example 6. The method of any one of Examples 1-5, wherein the second separating is performed by a distillation process.

Example 7. The method of any one of Examples 1-6, wherein the second separating is performed in a second distillation column operated at a pressure between about 0.001 atm and about 10 atm.

Example 8. The method of any one of Examples 1-7, wherein the pressure is between about 0.01 atm and about 1 atm.

Example 9. The method of any one of Examples 1-8, wherein the second separating is performed in a second distillation column having between 1 theoretical plate and 200 theoretical plates.

Example 10. The method of any one of Examples 1-9, wherein the second separating is performed in a second distillation column operated at a reflux ratio between zero and about 100.

Example 11. The method of any one of Examples 1-10, wherein the second distillation column is operated at a temperature between about 20° C. and about 400° C.

Example 12. The method of any one of Examples 1-11, wherein the compound is removed from the second distillation column from the overhead at an overhead temperature between about 100° C. and about 300° C., inclusively.

Example 13. The method of any one of Examples 1-12, wherein the overhead temperature is between about 100° C. and about 115° C., inclusively.

Example 14. The method of any one of Examples 1-13, wherein the overhead temperature is between about 115° C. and about 180° C., inclusively.

Example 15. The method of any one of Examples 1-14, wherein the overhead temperature is between about 180° C. and about 210° C., inclusively.

Example 16. The method of any one of Examples 1-15, wherein the overhead temperature is between about 210° C. and about 230° C., inclusively.

Example 17. The method of any one of Examples 1-16, wherein the overhead temperature is between about 230° C. and about 250° C., inclusively.

Example 18. The method of any one of Examples 1-17, wherein the overhead temperature is between about 250° C. and about 270° C., inclusively.

Example 19. The method of any one of Examples 1-18, wherein the initial separating is performed by at least one of a distillation process, an extraction process, a chromatography process, an adsorption process, or an absorption process.

Example 20. The method of any one of Examples 1-19, wherein the initial separating is performed by a distillation process.

Example 21. The method of any one of Examples 1-20, wherein the initial separating is performed in a first distillation column operated at a pressure between about 0.001 atm and about 10 atm.

Example 22. The method of any one of Examples 1-21, wherein the pressure is between about 0.01 atm and about 1 atm.

Example 23. The method of any one of Examples 1-22, wherein the initial separating is performed in a first distillation column having between 1 theoretical plate and 200 theoretical plates.

Example 24. The method of any one of Examples 1-23, wherein the initial separating is performed in a first distillation column operated at a reflux ratio between zero and about 100.

Example 25. The method of any one of Examples 1-24, wherein the first distillation column is operated at a temperature between about 20° C. and about 400° C.

Example 26. The method of any one of Examples 1-25, wherein the compound is removed from the first distillation column from the overhead at an overhead temperature between about 100° C. and about 300° C., inclusively.

Example 27. The method of any one of Examples 1-26, wherein the overhead temperature is between about 100° C. and about 115° C., inclusively.

Example 28. The method of any one of Examples 1-27, wherein the overhead temperature is between about 115° C. and about 180° C., inclusively.

Example 29. The method of any one of Examples 1-28, wherein the overhead temperature is between about 180° C. and about 210° C., inclusively.

Example 30. The method of any one of Examples 1-29, wherein the overhead temperature is between about 210° C. and about 230° C., inclusively.

Example 31. The method of any one of Examples 1-30, wherein the overhead temperature is between about 230° C. and about 250° C., inclusively.

Example 32. The method of any one of Examples 1-31, wherein the overhead temperature is between about 250° C. and about 270° C., inclusively.

Example 33. The method of any one of Examples 1-32, wherein the pyrolyzing comprises the upgrading of a pyrolysis vapor to the crude oil stream using a solid catalyst.

Example 34. The method of any one of Examples 1-33, wherein the pyrolyzing and the upgrading are performed in a single unit operation (in-situ).

Example 35. The method of any one of Examples 1-34, wherein the pyrolyzing and the upgrading are performed in different unit operations (ex-situ).

Example 36. The method of any one of Examples 1-35, wherein the solid catalyst comprises a transition metal positioned on a support.

Example 37. The method of any one of Examples 1-36, wherein the transition metal comprises at least one of platinum, palladium, or nickel.

Example 38. The method of any one of Examples 1-37, wherein the support comprises at least one of a metal oxide or a zeolite.

Example 39. The method of any one of Examples 1-38, wherein the biomass stream comprises at least one of a softwood, a hardwood, a grass, an agricultural waste, a municipal waste, or a forest residue.

Example 40. The method of any one of Examples 1-39, wherein the forest residue comprises a residue from pine.

Example 41. The method of any one of Examples 1-40, wherein the crude oil stream comprises at least one of an organic acid, a phenol, an alkylated phenol, a methoxy phenol, a polycyclic aromatic, an oxygenated aromatic, benzene, toluene, or a xylene.

Example 42. The method of any one of Examples 1-41, wherein crude oil stream comprises the compound.

Example 43. The method of any one of Examples 1-42, wherein the pyrolyzing and upgrading are performed in at least one of a fixed bed reactor, a fluidized bed reactor, or an entrained flow reactor.

Example 44. The method of any one of Examples 1-43, wherein the pyrolyzing and upgrading are performed at a temperature between about 350° C. and about 800° C., inclusively.

Example 45. The method of any one of Examples 1-44, wherein the pyrolyzing and upgrading are performed at a temperature between about 500° C. and about 600° C., inclusively.

Example 46. The method of any one of Examples 1-45, wherein the pyrolyzing is performed in at least one of a fixed bed reactor, a fluidized bed reactor, or an entrained flow reactor.

Example 47. The method of any one of Examples 1-46, wherein the pyrolyzing is performed at a temperature between about 350° C. and about 800° C., inclusively.

Example 48. The method of any one of Examples 1-47, wherein the pyrolyzing is performed at a temperature between about 500° C. and about 600° C., inclusively.

Example 49. The method of any one of Examples 1-48, wherein the upgrading is performed in at least one of a fixed bed reactor, a fluidized bed reactor, or an entrained flow reactor.

Example 50. The method of any one of Examples 1-49, wherein the upgrading is performed at a temperature between about 400° C. and about 500° C., inclusively.

Example 51. The method of any one of Examples 1-50, further comprising, before the second separating, extracting at least a portion of the crude oil, such that the crude oil is purified to contain a higher concentration of the compound.

Example 52. The method of any one of Examples 1-51, further comprising, after the second separating, from a mixture comprising the compound, crystallizing the compound, resulting in the compound in a purified solid form.

Method of Using Examples:

Example 1. A method of using any of the composition Examples listed above, the method comprising: applying the composition to an organism, wherein the applying results in the organism's metabolism being affected such that the organism is unable to function normally.

Example 2. The method of Example 1, wherein the applying results in the death of the organism.

Example 3. The method of either Example 1 or 2, wherein the compound comprises the structure

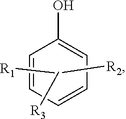

wherein: R₁ comprises at least one of a hydrogen atom, a hydroxyl group, a first alkoxy group, or a first hydrocarbon, R₂ comprises at least one of a hydrogen atom, a hydroxyl group, a second alkoxy group, or a second hydrocarbon, R₃ comprises at least one of a hydrogen atom, a hydroxyl group, a third alkoxy group, or a third hydrocarbon, and the composition has an LC₅₀ of less than about 150 mg compound/mL composition for an organism comprising the genus Leptinotarsa.

Example 4. The method of any one of Examples 1-3, wherein the organism comprises the Colorado Potato Beatle (Leptinotarsa decemlineata).

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A composition comprising:
a compound comprising the structure 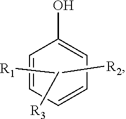
wherein:
R₁ comprises at least one of a hydrogen atom, a hydroxyl group, a first alkoxy group, or a first hydrocarbon,
R₂ comprises at least one of a hydrogen atom, a hydroxyl group, a second alkoxy group, or a second hydrocarbon,
R₃ comprises at least one of a hydrogen atom, a hydroxyl group, a third alkoxy group, or a third hydrocarbon, and
the composition has an LC₅₀ of less than about 150 mg compound/mL composition for an organism comprising the genus Leptinotarsa.

2. The composition of claim 1, wherein the compound is bioderived as determined by ASTM-D6866.

3. The composition of claim 1, wherein the compound is derived from an oil formed by catalytic fast pyrolysis of biomass.

4. The composition of claim 1, wherein at least one of the first hydrocarbon, the second hydrocarbon, or the third hydrocarbon comprises between 1 and 5 carbon atoms.

5. The composition of claim 1, wherein at least one of the first alkoxy group, the second alkoxy group, or the third alkoxy group comprises between 1 and 5 carbon atoms.

6. The composition of claim 1, wherein the compound comprises at least one of a trimethyl phenol, an ethyl-methyl phenol, a methoxy-methyl phenol, a 4-carbon, a 5-carbon phenol, a dimethyl phenol, an ethyl phenol, a propyl phenol, or a methoxy phenol.

7. The composition of claim 6, wherein the 4-carbon phenol comprises 2-methyl-5-(1-methylethyl).

8. The composition of claim 6, wherein the 5-carbon phenol comprises 2-ethyl-5-n-propyl phenol.

9. The composition of claim 1, wherein the compound comprises at least one of 4-methyl-1,2-benzenediol, 2-methoxy-4-methylphenol, a creosol, 4-ethylcatechol, 2,6-dimethyl-1,4-benzenediol, 2-methoxy-phenol, 4-hydroxy-3-methoxy-benzoic acid, 3-methyl-1,2-benzenediol, 4-ethyl-2-methoxy-phenol, 3,6-dimethyl-benzo[B]thiophene, 3,4-dimethoxy-phenol, p-cresol, 2,4-dimethyl-phenol, 2-methyl-phenol, hydroquinone, 4,5-dimethyl-1,3-benzenediol, 2-methoxy-4-propyl-phenol, or phenol.

10. The composition of claim 1, wherein the compound comprises at least one of 2-ethyl-5-n-propylphenol, 2-methyl-6-propylphenol, 2,5-diethylphenol, phenol, 2-(1-methylethyl)-phenol, 2-ethyl-phenol, 2-ethyl-4-methyl-phenol, 2-ethyl-4,5-dimethyl-phenol, 2-ethyl-5-methyl-phenol, 2-ethyl-6-methyl-phenol, 2-methoxy-phenol, 2-methoxy-3-(2-propenyl)-phenol, 2-methoxy-4-(1-propenyl)-phenol, (Z)-phenol, 2-methoxy-4-propyl-phenol, 2-methyl-phenol, 2-methyl-5-(1-methylethyl)-phenol, 2-propyl-phenol, 2,3-dimethyl-phenol, 2,3,6-trimethyl-phenol, 2,4,6-trimethyl-phenol, 2,6-dimethyl-phenol, 3-(1-methylethyl)-phenol, 3-ethyl-phenol, 3-methyl-phenol, 3-propyl-phenol, 3,4-dimethyl-phenol, 3,4,5-trimethyl-phenol, 4-(2-propenyl)-phenol, 4-ethyl-phenol, 4-methyl-benzenediol, or any other alkyl-benzenediol.

11. The composition of claim 1, wherein the LD₅₀ is effective for the organism further comprising at least one organism from the genus Trichoplusia, the genus Spodoptera, or the genus Drosophila.

12. The composition of claim 1, wherein the organism is in a stage of growth comprising at least one of a larval stage, a pupal stage, or an adult stage.

13. A method comprising:
a second separating of a compound comprising the structure 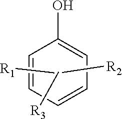
from an oil stream, wherein:
R₁ comprises at least one of a hydrogen atom, a hydroxyl group, a first alkoxy group, or a first hydrocarbon,
R₂ comprises at least one of a hydrogen atom, a hydroxyl group, a second alkoxy group, or a second hydrocarbon,
R₃ comprises at least one of a hydrogen atom, a hydroxyl group, a third alkoxy group, or a third hydrocarbon, and
the composition has an LC₅₀ of less than about 150 ml compound/kg composition for an organism comprising the Colorado Potato Beatle (Leptinotarsa decemlineata).

14. The method of claim 13, further comprising, prior to the second separating:
an initial separating of the oil stream and a secondary stream from a crude oil stream, wherein:
the crude oil stream comprises the compound derived from pyrolysis of a biomass stream.

15. The method of 14, further comprising, prior to the initial separating, producing the crude oil stream by pyrolyzing the biomass in at least one of a fast pyrolysis process or a catalytic fast pyrolysis process.

16. A method of using a composition, the method comprising:
applying the composition to an organism, wherein:
the applying results in the organism's metabolism being affected such that the organism is unable to function normally, and
the composition comprises a compound comprising the structure 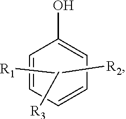
wherein:
R₁ comprises at least one of a hydrogen atom, a hydroxyl group, a first alkoxy group, or a first hydrocarbon,
R₂ comprises at least one of a hydrogen atom, a hydroxyl group, a second alkoxy group, or a second hydrocarbon,
R₃ comprises at least one of a hydrogen atom, a hydroxyl group, a third alkoxy group, or a third hydrocarbon, and
the composition has an LC₅₀ of less than about 150 mg compound/mL composition for an organism comprising the genus Leptinotarsa.
